(19) United States
(12) Patent Application Publication
(10) Pub. No.: US 2025/0024774 A1
(43) Pub. Date: Jan. 23, 2025

(54) MULTIPLE COVER CROP MIXED-SEED / MIXED-TYPE FERTILIZER PRECISION PLANTER

(71) Applicant: SOUTH DAKOTA BOARD OF REGENTS, Pierre, SD (US)

(72) Inventor: Ali Mirzakhani Nafchi, Brookings, SD (US)

(21) Appl. No.: 18/776,858

(22) Filed: Jul. 18, 2024

Related U.S. Application Data
(60) Provisional application No. 63/514,196, filed on Jul. 18, 2023.

(51) Int. Cl. A01C 21/00; A01C 7/06; A01C 7/08; A01C 7/10; A01C 19/02

(52) U.S. Cl. CPC A01C 21/005; A01C 7/06; A01C 7/082; A01C 7/084; A01C 7/102; A01C 19/02

(57) ABSTRACT

A precision planter having a frame configured to transport the precision planter through a crop area, at least one hopper coupled to the frame, and a seed dispersion system coupled to the frame. The seed dispersion system comprises a first seed meter, a funnel, and a seed dispersion tube, each configured to receive a first seed mix, which may include one or more types of seeds and/or fertilizer. The system also includes a fan, a seed dispersion tube, a seed dispersion head, and a plurality of seed hoses configured to deliver the first seed mix to the crop area. The seed dispersion system is configured to implement a prescription map of the crop area including at least two cover crop zones corresponding to seed mix(es) and or fertilizer prescriptions, which are determined based on location data. The seed dispersion system is configured to dispense the first seed mix at a first seed dispersion rate in the first cover crop zone.

### CROSS-REFERENCE TO RELATED APPLICATION(S)

This application claims the benefit under 35 U.S.C. § 119 (e) to U.S. Provisional Application 63/514,196, filed Jul. 18, 2023, and entitled MULTIPLE COVER CROP MIXED-SEED PRECISION PLANTER, which is hereby incorporated herein by reference in its entirety.

### GOVERNMENT SUPPORT

This invention was made with government support under Grant No. SA2200087, awarded by the USDA. The government has certain rights in the invention.

### FIELD

The various embodiments herein relate to precision planters for cover crop mixed seeds.

### BACKGROUND

Modern agricultural practices often result in reduced diversity in planted crops. Crops, once planted, draw nutrients from soil during growth. This can result in reduced soil health, which can affect crop yield, pollinator population, soil erosion.

One approach to increasing soil nutrition has been to plant cover crops. Scientists in the United States have successfully tested cost-effective cover crop-based crop production systems under different soil conditions during the past several years. The cover cropping system has potential to improve soil organic matter, water infiltration rate, water holding capacity, and environmental quality in combination with minimum or no-till system. It will also control pests (such as nematodes and weeds), reduce soil compaction, eliminate the need for annual deep tillage, and increase crop yield. In recent years, planting cover crops has become a popular approach among growers in many United States regions that results in many benefits to the soil and subsequent cash crops. Increasing the residue cover and soil organic matter improves the water infiltration rate and water holding capacity. This reduces the runoff, increases soil water retention, and enhances ground and surface water quality. Collectively, these changes produce an overall increase in soil health.

A considerable variation is present in soil texture, soil type, and other major factors within and across production fields that affect crop production and significantly impact management strategies. Nonetheless, a relatively uniform amount of cover crop seed mix is planted in a field in current cover cropping systems.

There is a need in the art for an improved device to plant an optimized variety of cover crops over a large area.

### BRIEF SUMMARY

Discussed herein are various embodiments of precision planters for planting cover crops. Such systems can include a frame, a hopper, and a seed dispersion system. The seed dispersion system can be configured to implement a prescription map of the crop area comprising at least two cover crop zones. The at least two cover crop zones can be determined based on at least one of geographic data, topographic data, soil data, water retention data, and weather data to determine the first seed mix. The first seed mix can correspond to a first cover crop zone. The seed dispersion system can be configured to disperse the first seed mix at a first seed dispersion rate in the first cover crop zone.

Such embodiments of precision planters can determine what mix of seeds can grow under the conditions of the cover crop zone(s). This can improve the growth and yield of the planted cover crops in certain zones. Such embodiments can also account for ongoing climate and/or topographic changes in its analysis.

In Example 1, a precision planter for planting cover crops comprises a frame, at least one hopper, and a seed dispersion system. The frame is configured to transport the precision planter through a crop area. The at least one hopper is coupled to the frame. The seed dispersion system is coupled to the frame. The seed dispersion system comprises a first seed meter configured to selectively receive a first seed mix from the at least one hopper, a first seed meter configured to selectively receive a first seed mix from the at least one hopper, a seed dispersion tube configured to receive the first seed mix, a first seed meter configured to selectively receive a first seed mix from the at least one hopper, a seed dispersion head in fluidic communication with the seed dispersion tube, and a plurality of seed hoses a first seed meter configured to selectively receive a first seed mix from the at least one hopper. The seed dispersion system is configured to implement a prescription map of the crop area comprising at least two cover crop zones. The at least two cover crop zones are determined based on at least one of geographic data, topographic data, soil data, water retention data, and weather data to determine the first seed mix. The first seed mix corresponds to a first cover crop zone. The seed dispersion system is configured to dispersion the first seed mix at a first seed dispersion rate in the first cover crop zone.

Example 2 relates to the precision planter according to Example 1, wherein the seed dispersion system is configured to disperse the first seed mix at a second seed dispersion rate in a second cover crop zone, the second seed dispersion rate being different from the first seed dispersion rate.

Example 3 relates to the precision planter according to Example 1, wherein the seed dispersion system is configured to disperse a second seed mix in a second cover crop zone, the second seed mix being different from the first seed mix.

Example 4 relates to the precision planter according to Example 1, wherein the seed dispersion system is operable using a controller.

Example 5 relates to the precision planter according to Example 1, wherein the geographic data comprises satellite data.

Example 6 relates to the precision planter according to Example 1, wherein the at least one hopper comprises a plurality of hoppers. Each hopper is associated with a respective seed meter. Each hopper is configured to dispense a respective seed mix. Each respective seed mix comprises at least one type of seed. The seed dispersion system is configured to mix together the respective seed mixes.

Example 7 relates to the precision planter according to Example 1, wherein the first seed mix comprises a single cover crop seed type.

In Example 8, a seed and/or fertilizer meter controller for a precision planner comprises a microprocessor, a seed metering adjuster, an encoder, a motor operably coupled to the seed metering adjuster, and a GPS receiver and antenna. The seed metering adjuster is configured to adjust a seed dispersion rate. The seed dispersion rate is the rate at which a seed is dispersed via a seed meter. The encoder is configured to receive feedback and is in communication with the microprocessor. The GPS receiver and antenna are in communication with a secondary device and the microprocessor.

Example 9 relates to the controller of Example 8, wherein the seed metering adjuster comprises a linear actuator operably coupled to the motor.

Example 10 relates to the controller of Example 8, wherein the seed metering adjuster comprises a code generator and an encoder operably connected to the motor.

Example 11 relates to the controller of Example 10, wherein the seed metering adjuster comprises a linear actuator operably connected to the motor and encoder.

Example 12 relates to the controller of Example 8, wherein the controller comprises a control module electronically coupled to the seed metering adjuster and the motor, wherein the control module is configured to control the seed metering adjuster.

Example 13 relates to the controller of Example 12, wherein the control module is configured to receive at least one of a feedback signal or an input signal to modify a seed mix being dispersed by the precision planter, wherein the seed mix comprises at least one seed type.

Example 14 relates to the controller of Example 13, wherein the feedback signal or control signal comprises at least one of a manual input signal, a sensor signal, and a GPS signal.

Example 15 relates to the controller of Example 14, wherein the feedback signal or control signal comprises an analog signal, and wherein the control module is configured to convert the analog signal to a digital signal.

Example 16 relates to the controller of Example 13, wherein the feedback signal or control signal comprises a digital signal, and wherein the control module is configured to convert the digital signal to an analog signal.

Example 17 relates to the controller of Example 10, wherein the code generator comprises a logic unit configured to generate a mixture of seed and/or seed dispersion rate.

Example 18 relates to the controller of claim 8, wherein the motor comprises a stepper motor.

In Example 19, a seed mixing device comprises at least one layer. The at least one layer comprises a layer body comprising a first end and a second end opposite the first end, at least one opening extending from the first end to the second end at at least one angle, and wherein the at least one angle of the at least one opening is greater than an angle of repose of a seed to be disposed in a hopper.

Example 20 relates to the seed mixing device of Example 19, wherein each of the at least one layers is configured to be disposed above or below an adjacent layer, and each of the at least one angles of a layer comprises a different angle and/or orientation from the at least one angle of an adjacent layer.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

FIG. 1A is a perspective front view of an embodiment of a mixed-seed cover crop precision planter, in accordance with one embodiment.

FIG. 1B is a perspective top view of the mixed-seed cover crop precision planter of FIG. 1A, in accordance with one embodiment.

FIG. 1C is a top view of the mixed-seed cover crop precision planter of FIG. 1A, in accordance with one embodiment.

FIG. 1D is a rear view of the mixed-seed cover crop precision planter of FIG. 1A, in accordance with one embodiment.

FIG. 2 is a cross-sectional side view of the mixed-seed cover crop precision planter of FIG. 1A, in accordance with one embodiment.

FIG. 3 is a perspective view of the seed meters of a mixed-seed cover crop precision planter, in accordance with one embodiment.

FIG. 4 is an expanded perspective view of the seed meters of FIG. 3, in accordance with one embodiment.

FIG. 5 is another perspective view of the seed meters of FIG. 3, in accordance with one embodiment.

FIG. 6 is a partial rear view of an embodiment of a mixed-seed cover crop precision planter including a display screen, in accordance with one embodiment.

FIG. 7 is a perspective view of a seed dispersal head of a mixed-seed cover crop precision planter, in accordance with one embodiment.

FIG. 8 is a perspective view of a seed hopper, in accordance with one embodiment.

FIG. 9A is a perspective view of a seed hopper, in accordance with one embodiment.

FIG. 9B is a top view of the seed hopper of FIG. 9A, in accordance with one embodiment.

FIG. 9C is a cross-sectional side view of the seed hopper of FIG. 9A, in accordance with one embodiment.

FIG. 10 is a perspective view of an exemplary prescription map, in accordance with one embodiment.

FIG. 11 is a perspective view of a controller of a precision planter, in accordance with one embodiment.

FIG. 12 is a perspective view of a seed metering mechanism, in accordance with one embodiment.

FIG. 13 is a flow chart of a method of analyzing data to determine a seed mix, in accordance with one embodiment.

### DETAILED DESCRIPTION

The embodiments herein are directed to precision planters. Specifically, the embodiments herein are directed to precision planters for use in mix-seed cover crop planting.

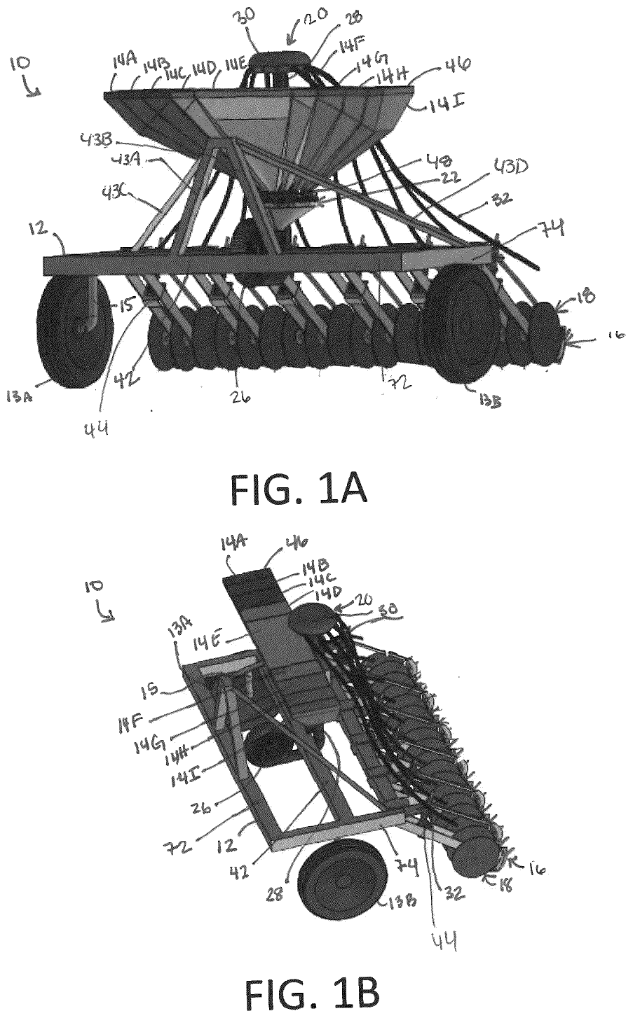

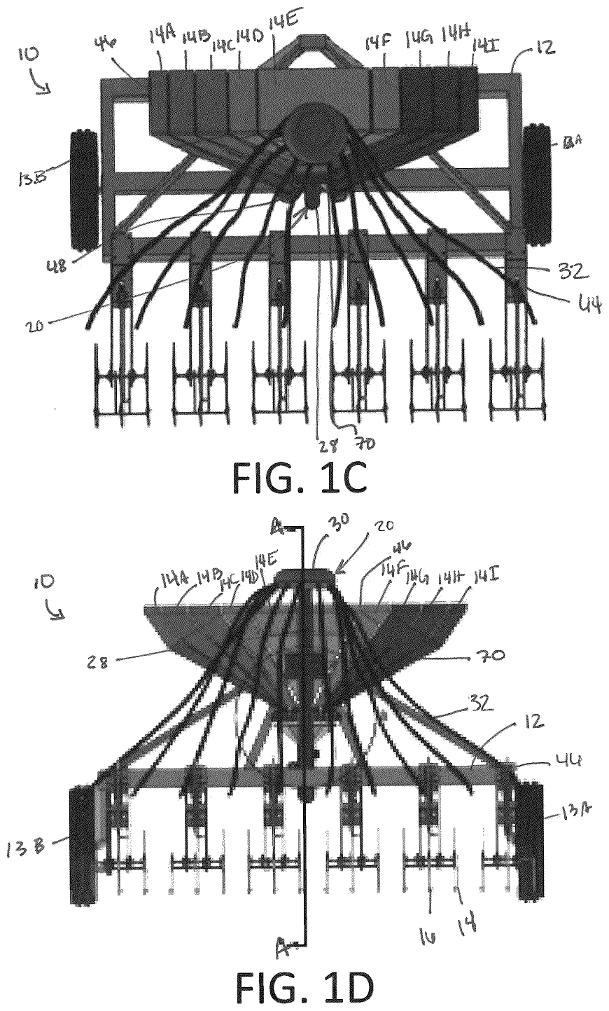

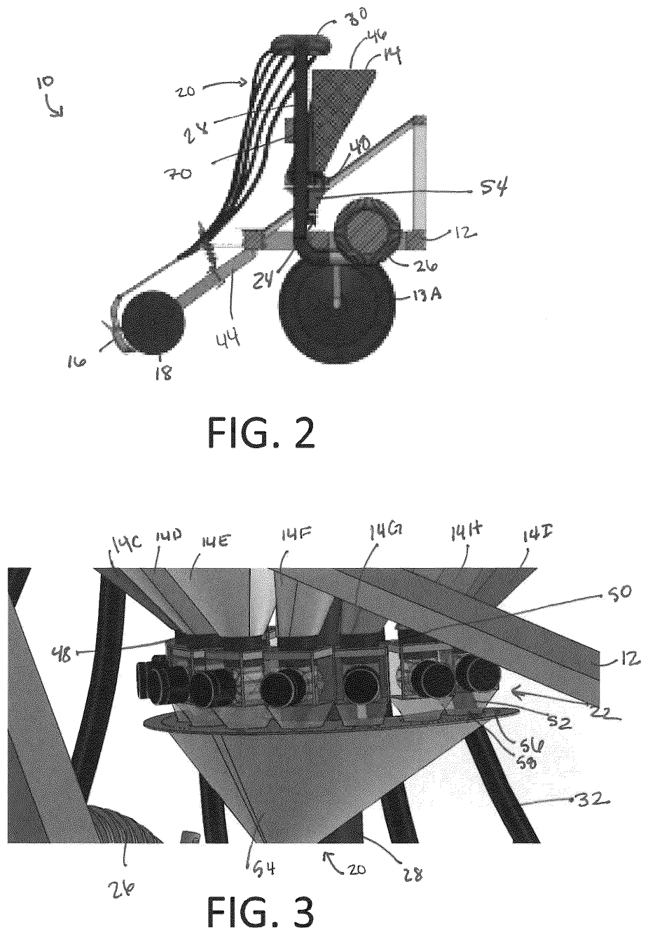

FIGS. 1A-1D show one embodiment of a mixed-seed cover crop precision planter 10. As best shown in FIGS. 1A and 1B, the planter has a frame 12, a plurality of hoppers 14A-14I, a seed dispersion system 20, and a plurality of gauge wheels 18 and furrow openers 16. As best shown in FIGS. 2 and 3 (which will be discussed in additional detail below), the seed dispersion system 20 includes a plurality of hopper seed meters 22, a main seed meter 24, a fan 26, a seed dispersal tube 28, a seed dispersal head 30, and a plurality of seed hoses 32.

The frame 12 is a generally horizontal structure. In some embodiments, the frame 12 is rectangular as best shown in FIG. 1B. The frame 12 can have two or more transport components-such as wheels or tracks-attached thereto. For example, in the exemplary implementation as shown, the frame 12 has two wheels 13A, 13B rotatably attached thereto. More specifically, as best shown in FIGS. 1A, the frame 12 has two wheel attachment structures 15 extending therefrom, and the two wheels 13A, 13B are rotatably attached to the structures 15. (Only one of the attachment structures 15 is visible in FIG. 1A because of the angle of view. Alternatively, any known transport components can be attached to the frame 12.

In one embodiment as best shown in FIG. 1B, the frame 12 is a rectangular frame 12 made up of two long frame beams 72 and two short frame beams 74. Further, in the specific implementation as shown, the frame 12 also has one elongate crossbeam 42 that is disposed between the two long frame beams 72 and attached at each end to the two short frame beams 74. In this specific embodiment, the wheel attachment structures 15 are attached to and extend from the two short frame beams 74.

In accordance with certain embodiments, the frame 12 can also have a vertical coupling structure 43 made up of four vertical beams 43A-D extending vertically from the horizontal structure as best shown in FIGS. 1A and 1B. In the specific implementation as shown, the four vertical beams 43A-43D include two shorter beams 43A, 43B and two longer beams 43C, 43D. The two shorter beams 43A, 43B can extend generally perpendicularly from the frame 12, specifically from one of the long frame beams 72 of the frame 12. The two longer frame beams 43C, 43D are attached to and extend at an angle from a top portion of the two shorter beams 43A, 43B as shown. In one embodiment, the vertical coupling structure 43 couples the planter to a vehicle to be driven to maneuver the planter. In some embodiments, a vehicle, such as a tractor, includes a coupling structure (not pictured) that can be coupled to the vertical coupling structure 43. In some certain embodiments, this coupling structure on the tractor can be coupled to the tractor's three-point hitch.

The frame 12 also supports the plurality of hoppers 14A-14I, the seed dispersion system 20, and the plurality of gauge wheels 18 and furrow openers 16. As best shown in FIGS. 1A, 1B, and 1C, the gauge wheels 18 and furrow openers 16 can be coupled to the rear long frame beam 72. In the specific implementation as shown, the furrow openers 16 and plurality of gauge wheels 18 can be coupled to the frame 12 via attachment structures 44. Alternatively, the furrow openers 16 and gauge wheels 18 can be coupled to the frame 12 via any known attachment structures or features.

As mentioned above, the precision planter 10 has a plurality of seed hoppers 14A-14I. Each hopper 14A-14I can receive and carry cover crop seeds. In the specific exemplary embodiment herein, the planter 10 has 9 hoppers 14A-14I. Alternatively, the planter 10 can have 1 to 20 hoppers. In a further alternative, the precision planter 10 can have any number of hoppers based on the number of different types of seed to be planted. In one embodiment, each hopper 14A-14I can contain one or more different types of seeds that differ from the types or mixes of seeds carried in the other hoppers. The seeds are of varying shapes and sizes, depending on the type of cover crop to be planted.

As shown in FIGS. 1A-1D, each hopper 14A-14I has a top opening 46 defined in a top portion of the hopper 14 that is configured to receive seed. Further, each hopper 14A-14I also has a bottom opening 48 defined in a bottom portion of the hopper 14 that is in fluidic communication with a seed meter 22 coupled thereto such that each hopper 14A-14I is coupled to a seed meter 22A-22I. As best shown in FIGS. 1A and 1D, each hopper 14A-14I is tapered from the top portion to the bottom portion such that the top portion has a larger cross-sectional diameter than the bottom portion. Thus, the top opening 46 of the hopper 14 is wider than the bottom opening 48. As a result of this tapered configuration, the top opening 46 of each hopper 14A-14I has a cross-sectional diameter that is large enough to readily receive seed that is placed into the hopper 14A-14I. Further, the smaller cross-sectional diameter of the bottom portion and the bottom opening 48 of each hopper 14A-14I makes it possible for the bottom opening 48 to dispense seeds into the hopper seed meter 22A-22I coupled thereto. (Please note that the plurality of the meters 22A-22I are denoted generally as 22 in the figures.) As best shown in FIG. 3, according to certain embodiments, a first connection collar 50 can be coupled to and between the bottom opening 48 of each hopper 14A-14I and each adjacent seed meter 22A-22I. Alternatively, each bottom opening 48 and each adjacent meter 22A-22I can be coupled via any known component or mechanism, or alternatively are coupled directly together.

As previously discussed, the seed dispersion system 16 includes a plurality of hopper seed meters 22A-I (with each coupled to the bottom of one of the hoppers 14A-14I as discussed above), a main seed meter 24, a fan 26, a seed dispersal tube 28, a seed dispersal head 30, and a plurality of seed hoses 32. Each seed meter 22, 24 can be any seed meter compatible for use with a precision planter. Each hopper seed meter 22 can include a plurality of blades to facilitate movement of a seed through each hopper seed meter 22. The hopper seed meters include a metering mechanism that can be controlled by a default software or the software described below.

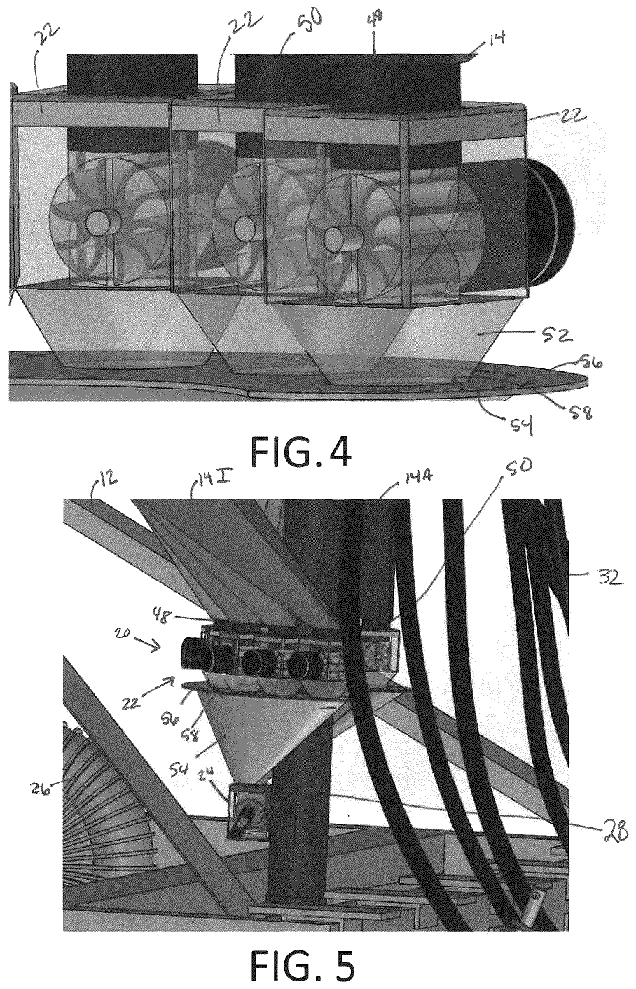

As part of the seed dispersion system 16, a collection funnel 54 is disposed between and coupled to the hopper seed meters 14A-14I and the main seed meter 24. That is, the funnel 54 is in fluidic communication with both the hopper seed meters 14A-14I and the main seed meter 24 such that the funnel 54 is disposed below the hopper seed meters 14A-14I and above the main seed meter 24. Thus, each of the hopper seed meters 22A-I can dispense seed into the funnel 54 such that the funnel 54 directs the seeds from each of the hopper seed meters 22 to the main seed meter 24. As best shown in FIG. 5, the funnel 54 is disposed adjacent to the seed dispersal tube 28 and, in some embodiments, can have some portion of the funnel 54 wrapped or curved around the tube 28. As best shown in FIG. 4, the hopper seed meters 22 can be in communication with the funnel 54 via a second connection collar 52. The funnel 54 is wide enough such that the funnel 54 is in communication with each bottom opening 48 of each hopper 14A-14I. In certain embodiments, the funnel 54 can include a covering or lid that has a plurality of openings defined therein such that the openings are aligned with and in communication with the second connection collars 52.

As best shown in FIG. 5, the main seed meter 24 is coupled to and in fluidic communication with a seed dispersal tube 28 such that seed from the funnel 54 is metered into the seed dispersal tube 28. Further, in certain embodiments as best shown in FIGS. 1B and 2, a fan 26 is coupled to the seed dispersal tube 28. The fan 26 blows air through the seed dispersal tube 28 to transport seed therethrough. That is, the pressure created within the tube 28 by the fan 26 pushes the seeds metered into the tube 28 by the meter 24 upward through the seed dispersal tube 28 and into the seed dispersal head 30, as best shown in FIGS. 1D and 2. According to one implementation, the fan 26 can create air velocity within the tube 28. The air velocity can be the minimum air velocity greater than the terminal velocity of a seed within the tube. The air velocity can vary depending on the speed of the tractor and the terminal velocity of the seeds therein. The air can travel at any velocity required to move a seed upward through the seed dispersal tube 28 from the meter 24 to the head 30. In the various embodiments herein, the air velocity in the tube 28 can be adjusted to accommodate for changes in the seed mix to be planted, along with the ground speed of the planter.

As best shown in FIGS. 1D, 2, and 7, the seed dispersal head 30 is configured to distribute the seeds from the dispersal tube 28 to the seed hoses 32. More specifically, the head 30 has a cone-like structure (not pictured) within the head 30 that can direct the seeds to the plurality of seed hoses 32. In the exemplary embodiment as shown, the seed dispersal head 30 is round. Alternatively, the head 30 can be any known shape. The seed dispersal head 30 includes an outer wall 60 having a plurality of openings 62 defined therein. In certain embodiments, the seed dispersal head 30 can be any known seed dispersal head available with any known commercial air seeder, such as those available from John Deere™ and/or Case IH™. Each opening 62 has a seed hose 32 coupled thereto such that the hose 32 is in fluidic communication with the interior of the head 30. In one implementation, the openings 62 are about equidistant from one another radially on the outer wall 60. Thus, the seeds urged upward from the tube 28 into the head 30 are distributed substantially evenly out of the hoses 32.

As best shown in FIGS. 1C and 1D, the seed hoses 32 extend from the seed dispersal head 30 to the gauge wheels 18 and furrow openers 16 near the soil such that the hoses 32 can assist in transporting the seeds from the head 30 to the location at which the seeds are to be planted. More specifically, in some embodiments, the ends of the hoses 32 opposite the seed head 30 are disposed to deposit seeds into a trench or furrow within the ground. In other embodiments, the ends of the hoses 32 opposite the seed head 30 are disposed to broadcast or disperse the seeds on top of the soil. The seed hoses 32 can vary in length. The length can be any length sufficient for the hoses 32 to extend from the seed dispersal head 30 to the desired location adjacent to the soil. Thus, in at least some embodiments, the various seed hoses 32 on the planter 10 will have different lengths.

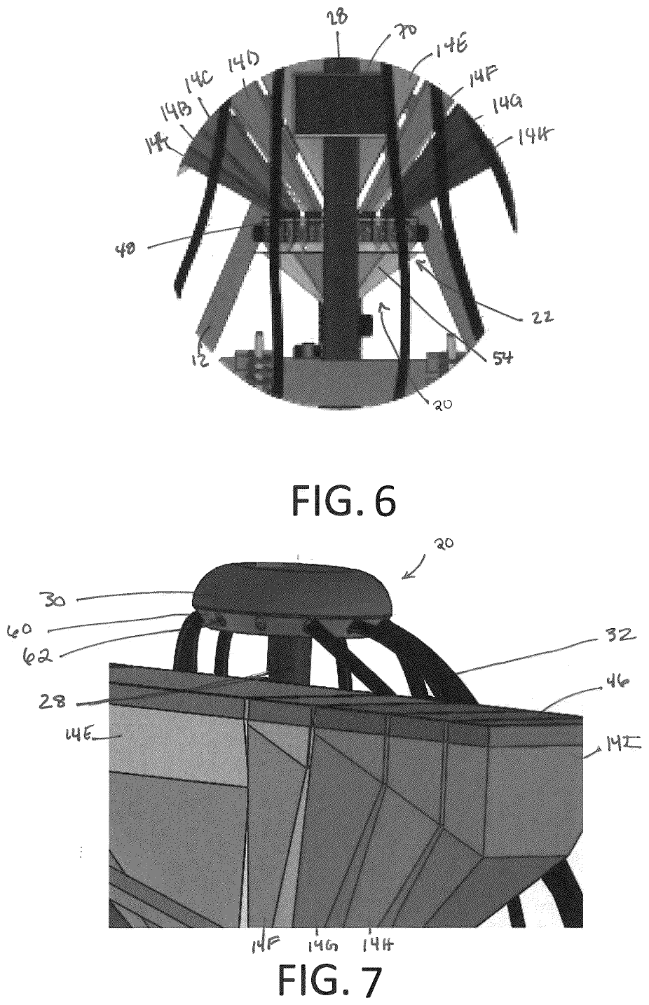

In certain embodiments as best shown in FIGS. 1D, 2, and 6, an interface 70 is located on the device 10. In the specific exemplary embodiment as shown, the interface 70 is a computer screen 70 that is disposed on or otherwise attached to the seed dispersal tube 28. Alternatively, the interface 70 can be any known user interface that can be disposed anywhere on the planter 10. In one embodiment, the interface 70 can be used to access the GPS system used by the device 10. Further, the interface 70 can also display and/or be used to access features such as the software's code-generating capabilities.

The software generates a code based off of user-inputted information. A user can input a seeding rate that the software then uses to generate a code. The generated code can then generate a prescription map for the multiple types of seeds and possible rates. The rate can be determined in either pounds per acre or seed number per acre, in some embodiments. By integrating multiple types of seeds and rates into one prescription map, the quantity of computations for each zone wherein cover crops are to be planted is reduced, which decreases the time spent preparing to plant.

According to various embodiments, the planter 10 includes software that is configured to use GPS data to adjust the type of seed and/or the quantity of each seed in the mixture to be planted based on the specific location of the planter 10 in the field and the known soil, topographical, and other characteristics of that location. That is, a crop field usually has various different characteristics in various different areas or locations within the field. The various characteristics that can vary include, but are not limited to, soil type, depth of the top soil, amount of moisture retained therein, the slope of the field at that particular location, the direction of the slope, and various other parameters. Given the varied nature of the soil, topography, etc. across a field as described herein, the various planter embodiments herein are configured to utilize the information about the characteristics at any specific location within the field to determine the mix of different cover crop seeds to plan at that location.

In certain embodiments, all of the specific characteristics about the specific locations or areas of a specific field are added to an electronic map or any electronic collection of information about the specific field. This information is overlayed or combined with GPS information such that the specific field characteristics of each specific GPS location within the field is known. This information is then utilized by the software provided with the various embodiments herein such that the exact location of the planter 10 within the field is tracked and the field characteristics at the specific location can be used to determine the exact mix of cover crop seeds to be selected and planted at that location. Thus, as the planter 10 moves across the field, the software tracks the movement via the GPS tracking system, correlates it to the characteristics of the field at that location, and identifies the desired seed mix for that specific location (based on those characteristics). This information is then utilized by the software to transmit instructions to the hopper seed meters 22A-22I and the main seed meter 24 to precisely control and adjust the mix of cover crop seeds being delivered to the soil by the planter 10. In one embodiment, the software can generate a code to be delivered to and read by the metering mechanism of each meter 22A-22I, 24, which then is actuated to meter seeds from the desired hoppers 14A-14I (and not from the other hoppers 14A-14I) and into the seed dispersal system 20. As a result, the seeding rate and types of seed in the seed mix are controlled by the software (utilizing the field characteristic information and the GPS tracking). The software can control both the speed at which the seeds are deposited into the hopper seed meters and the speed at which the seeds are deposited into the main seed meter. These can be different speeds, or the same speed. In comparison to known cover crop planting/seeding systems, the automatic adjustment of the seeding rate and seed types in the mix by the software in the various implementations herein eliminates the time and effort for manual adjustment of seeding types/rates in the known systems.

In use, seeds are added to the hoppers 14A-14I. Depending on the characteristics of the field and the desired mix of cover crops to be planted, any number of the hoppers 14A-14I can be filled with the desired types of seed. In one embodiment in which the desired mix of seeds to be planted includes nine different types of seeds, every hopper 14A-14I can be filled, with each hopper 14A-14I containing a different type of seed. Alternatively, in those embodiments in which less than nine different types of seeds are desired, then less than nine of the hoppers 14A-14I need be filled in order for the planter 10 to be used. As discussed above, the software can identify the geographic location of the planter 10 in the field (via GPS) and determine the type and quantity of seed to be planted at said geographic location based on the known characteristics of that location.

Based on the instructions from the software, at least one of the hopper seed meters 22A-22I are actuated to meter seed from those respective one or more hoppers 14A-14I. As such, seeds are urged from those one or more hoppers 14A-14I and into the funnel 54. At this point, the main seed meter 24 is actuated to meter seed out of the funnel and into the seed dispersion tube 28. The fan 26 urges air through the seed dispersion tube 28 such that the seed is urged upward to the seed dispersion head 30 and through the head 30 to the plurality of hoses 32. The seed then passes through and exits the plurality of hoses 32 at the desired location in the soil as described above.

In the various embodiments herein, the use of multiple hoppers 14 and the seed dispersion system 20 in combination with the software, field characteristics, and GPS information can result in the desired mix of different types of seeds being consistently planted. In planters where seeds are housed in only one hopper, vibrations occurring use of the machines can cause movement of the seeds within the hopper. This can cause smaller seeds to gather at the bottom of the hopper, and the larger seeds to become positioned on top of the smaller seeds. This results in uneven distribution of smaller seeds compared to larger seeds. Including a plurality of hoppers and a software-controlled seed dispersal system mitigates this disparity in planted seeds.

As with many planters, movement of the planter 10 causes the gauge wheels 18 to rotate such that the wheels can determine the ground speed at which the planter is moving across the field and thus the rate at which the seeds are to be planted. Movement also causes the furrow opener 16 to engage with the soil to create a furrow in which each seed can be planted, as discussed above.

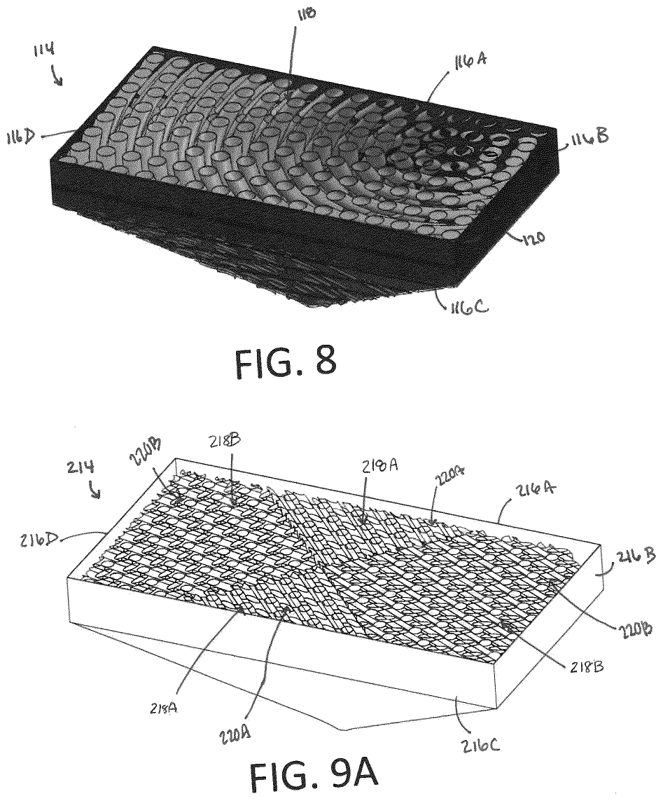

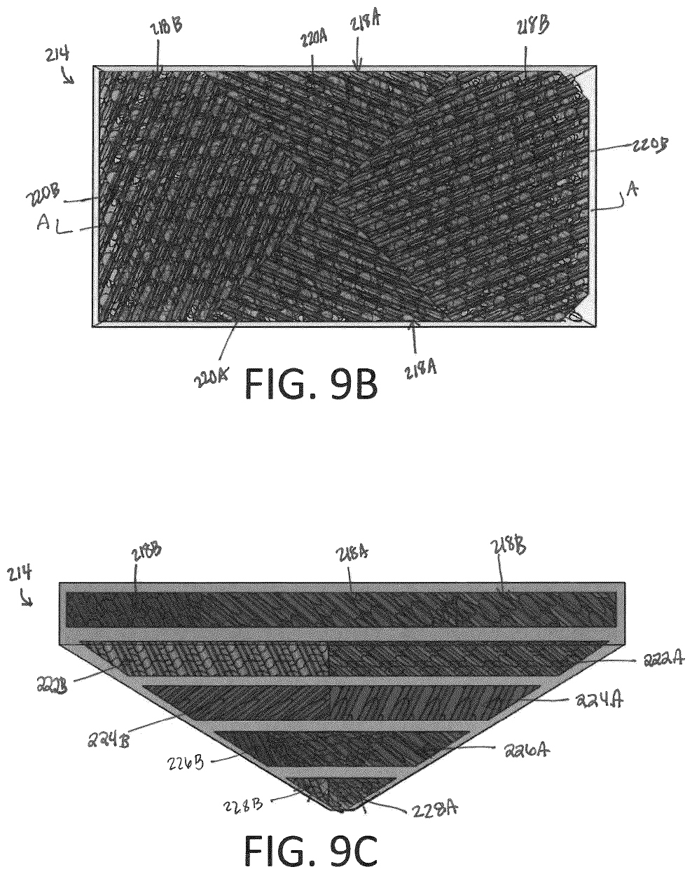

In further embodiments, certain hopper embodiments are contemplated for use with the various precision planter embodiments herein or with any seed planter. More specifically, the hopper embodiments as shown in FIG. 8 and FIG. 9A-9C are structured to prevent or reduce the uneven distribution of seeds within the hopper. FIG. 8 shows one implementation of a hopper 114 having a “honeycomb” structure 118. More specifically, the structure 118 can include a plurality of angled tubes 120 configured to direct seed in a particular direction within the hopper 114. The structure 118 is disposed within the hopper 114 and positioned between the walls 116A-D of the hopper 114. In some embodiments, the structure can extend from wall 116A to the opposing wall 116C and further can extend from wall 116B to the opposite wall 116D. When seed is added into the hopper 114, the structure 118 can help to prevent the uneven distribution of seeds within the hopper 114, as described above. Thus, adding the structure 118 to the hopper 114 results in substantially equal distribution of seeds of all sizes throughout the hopper 114. In addition to distribution of the seeds, the structure 118 can also assist with and/or enhance the mixing of different types of seeds within the hopper 114.

FIGS. 9A and 9B show an alternative hopper embodiment 214 having at least two separate honeycomb structures 218 disposed within the hopper 214. More specifically, as best shown in FIG. 9C, the exemplary hopper 214 as shown has five layers of structures 218, 222, 224, 226, 228, with each layer made up of at least two structures. For example, as best shown in FIGS. 9A and 9B, the top layer 218 has four different structures 218A, 218B, 218C, 218D, while each of the additional four layers have at least two structures. That is, layer 222 has two structures 222A, 222B, layer 224 has two structures 224A, 224B, layer 226 has two structures 226A, 226B, and layer 228 has two structures 228A, 228B. Alternative hopper embodiments can include at least one layer of honeycomb structures 218. In a further alternative, the hopper 214 can have two, three, four, five, six, seven, eight, nine, ten, or any number of layers. Additionally, each layer of the hopper 214 can have at least one honeycomb structure. Alternatively, each layer can have two, three, four five, six, seven, eight, nine, ten, or any number of structures.

The layers can include tubes 220 disposed at a variety of angles. The angle of the tube can be configured to maneuver the seed throughout the hopper. In doing so, the angle of the tube can be related to the angle of repose of a seed in relation to the honeycomb structure. The angle of the tube can also be determined using the drag coefficient of the seed and the coefficient of friction of the material comprising the honeycomb structure tube. For example, in instances where a seed has a greater drag coefficient, the corresponding angle of the tube will be greater than for a seed with a lower drag coefficient. The size of the tubes can vary depending on the seed. The diameter of the tubes can be any diameter sufficient to accommodate the passage of a seed therethrough. In some examples, the diameter of the tubes can range from less than 1 inch to 3 inches. In some embodiments, the minimum diameter of each tube is no smaller than the width of the largest seed to be placed in the hopper. Further, in those embodiments in which the hopper has at least two tubes, the maximum diameter of each tube is the width of the hopper less the diameter of the other tube.

As best shown in FIGS. 9A and 9B with respect to layer 218, each layer of honeycomb structures can include multiple configurations of the structures (such as structures 218A, 218B in layer 218 as shown). The multiple configurations of the structures 218A, 218B can be characterized by the angled openings 220A, 220B being angled in different directions. Some examples include two sections of the hopper having a first configuration 218A and two sections of the hopper having a second configuration 218B. Alternatively, each structure in the layer can have a different configuration, or two or more of the structures can have the same configuration.

In other embodiments, the honeycomb configuration can include one continuous layer occupying the hopper (not pictured). The tubes within the honeycomb configuration can extend from one end of the hopper to the other end of the hopper (i.e., left-to-right; right-to-left) continuously throughout the hopper. In other embodiments, the tubes within the honeycomb configuration can be angled within the layer such that the direction of the tube(s) change throughout the layer. The variation in angles of the tubes results in greater mixing of the seeds within the hopper.

According to various implementations, each of the structures in any hopper embodiment herein can include the same angled openings at angles varying from an adjacent structure, or the structures can include openings of different shapes and sizes. In some examples, each layer can include a honeycomb structure with the same sized openings, however, the openings are angled differently throughout the layer 218A, 218B, 222A, 222B, 224A, 224B, 226A, 226B, 228A, 228B. Regardless of the specific configuration, in the various embodiments herein, the structures in each layer are horizontally offset from the structures in the adjacent layer(s) such that the seeds cannot fall unimpeded through the layers, thereby reducing the speed at which the seeds travel through the hopper and thus preventing the smaller seeds from gathering at the bottom of the hopper.

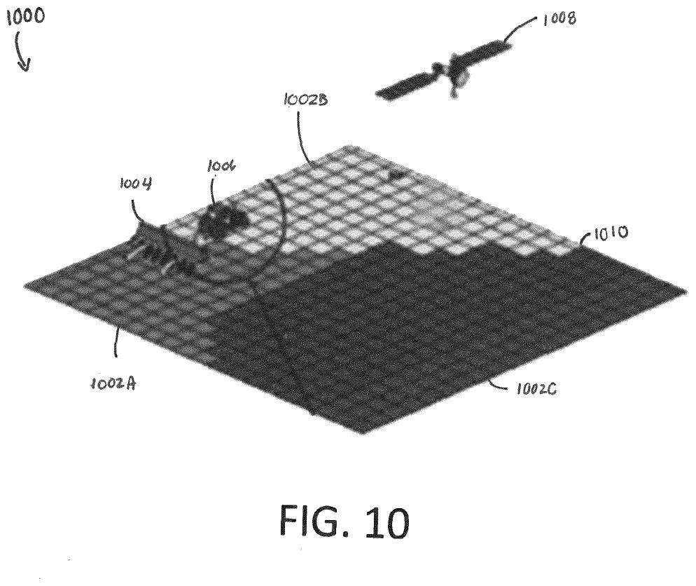

FIG. 10 shows an embodiment 1000 of a planter 1004 in use. Any embodiments of planters described herein can be compatible for use as described below. The planter 1004 can be pulled by a tractor 1006 or other machinery over a crop area 1002. The crop area 1002 can be represented using a prescription map 1010 such as the map 1010 of FIG. 10. The crop area 1002 can be divided into zones 1002A, 1002B, 1002C. Zones 1002A-1002C can be determined based on the type of cover crop(s) to be planted in each of the respective zones 1002A-1002C. The prescription map 1010 can represent one, two, three, four, five, six, seven, eight, nine, ten or more zones. The location represented by the prescription map 1010 can include any number of zones 1002. The prescription map 1010 can be pre-set or updated in real time, that is, while the planter 1004 is deployed and in use.

The planter 1004 can move on a path throughout the zones 1002A-1002C. In some embodiments, the planter 1004 can be pulled through the zones 1002A-1002C by a tractor 1006 or other agricultural equipment configured to pull a planter (such as precision planter 1004). The location of the tractor 1006 can be monitored via satellite 1008 in communication with a GPS system 1106 of the planter 1004 (discussed in further detail below). As the tractor 1006 pulls the planter 1004 through the various zones 1002A-1002C, the satellite 1008 can track the tractor 1006 location. The satellite 1008 can be in communication with various planter components (discussed in further detail below) and share location information with said various planter components, which can use that information to determine seed mix(es) to dispense in various zones 1002A-1002C. Each zone can correspond to a different seed mix. The term “seed mix” (or seed mixes), as used herein, may be used to refer to seeds, fertilizers, or a combination of seeds and fertilizers. A seed mix may include mixes of various types of seeds and/or fertilizers. In some cases, a seed mix may be comprised of a single type of seed or fertilizer. Likewise, reference to various systems or components herein, such as a seed dispersion system, seed meter, seed dispersion tube, seed dispersion head, seed hoses, etc., are all understood to be equally applicable to use with fertilizers in addition to seeds.

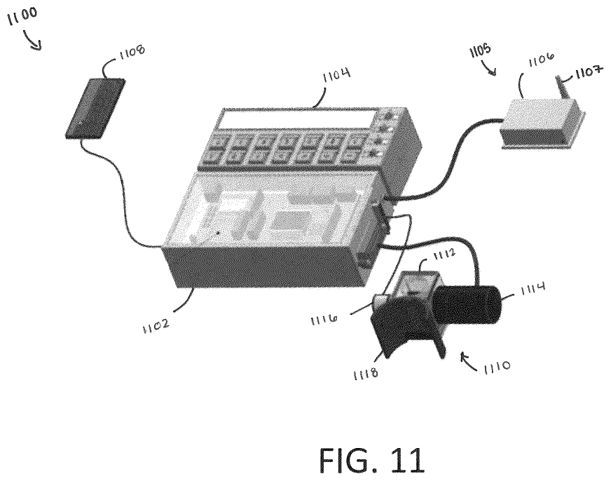

FIG. 11 shows a controller 1100 that can be used to determine the mixture of seeds to be planted by the planter and/or seed planting rates. The controller 1100 can include a microprocessor 1102, a code generator 1104, a GPS system 1105, a secondary device 1108, and a metering mechanism 1110. The controller 1100 can be located at any location on the planter 1004. In some embodiments, the controller 1100 can be located on a portion of the planter 1004 that is accessible and/or visible to an operator, for example on the frame 12 or along the seed dispersal tube 28.

The microprocessor 1102 can be operably connected to the code generator 1104, the GPS system 1105, the secondary device 1108, and metering mechanism 1110. The microprocessor 1102 can be configured to receive information gathered and sent by a GPS receiver 1106. This information can include, but is not limited to, planter location information. The planter location information can be used to determine seed mix and/or seed rates (seed delivery rates). The microprocessor 1102 can analyze information including, but not limited to, soil information, water retention data, topographic data, and/or other geographic data to determine which cover crop(s) and what quantity of said crops to plant at a location. Seed mix and/or seed rates can be used to generate a code using the code generator 1104. The code generator 1104 can be adjacent the microprocessor 1102 on the planter 1004. In some embodiments, the microprocessor 1102 can be a Raspberry Pi™; however, other embodiments of the microprocessor 1102 can be any type of microprocessor.

The GPS system 1105 can include a variety of features. For example, in some embodiments, the GPS system 1105 has GPS receiver 1106, which may include an antenna 1107. The GPS receiver 1106 and antenna 1107 can be configured to connect to a secondary device 1108. This can include, but is not limited to, a computer, tablet, or smartphone, such as the smartphone 1108 of FIG. 11. The GPS system 1105 can track a location of the precision planter 1004 via an RTK GPS sensor (or other suitable format GPS sensor) and send the sensed location to the microprocessor 1102.

The microprocessor 1102 can also be in communication with the seed metering mechanism(s) 1110 of the planter 1004. In particular, the microprocessor 1102 can control the rate at which seeds are dispensed through the seed meter 1122 via a motor 1114 and encoder 1116. The code generator 1104 can generate a code to be communicated with the encoder 1116. The encoder 1116 can be operably connected to the motor 1114, which can control the speed at which a seed travels through the seed meter 1122 and into the seed dispersion tube 1118. In some embodiments, the motor 1114 can be a stepper motor and/or the encoder 1116 can be a feedback encoder. In other embodiments, the motor 1114 can be any motor.

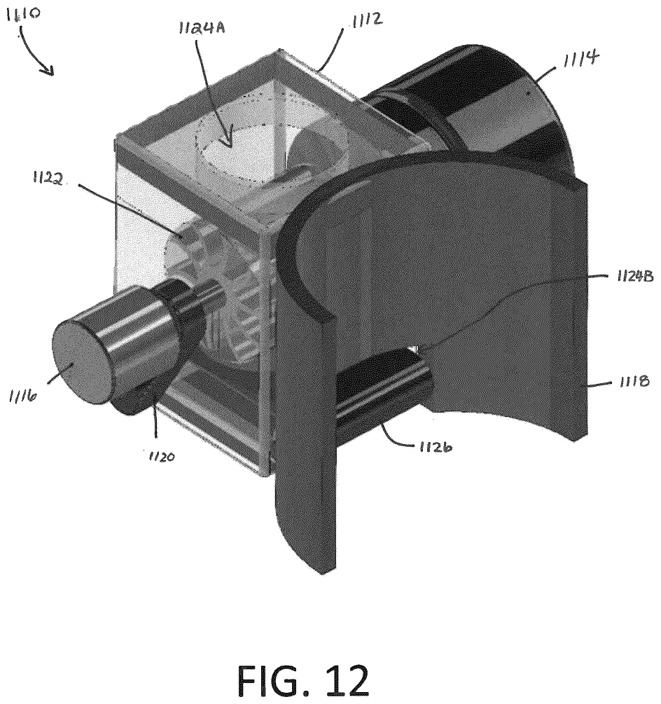

FIG. 12 shows a seed metering mechanism 1110. The seed metering mechanism can be configured to receive a seed at an opening 1124A and eject a seed at a separate opening 1124B. The seed can be maneuvered into the seed meter body 1112 such that it comes into contact with the seed meter 1122. The seed meter 1122 can rotate about an axis at a speed that can be modified by the microprocessor 1102. For example, the microprocessor 1102 can receive a code generated by the code generator 1104. The encoder 1116 can be operatively connected to the motor 1114 and communicate with the motor 1114 to modify its speed. This modification changes the speed at which the seed meter 1122 rotates about its axis of rotation, which changes the rate at which seeds are dispensed from the seed metering mechanism 1110. When a seed exits the seed metering mechanism 1110, the seed meter 1122 can deposit a seed onto a conveyor belt 1126 configured to transport the seed through an exit opening 1124B and into a seed dispersion tube 1118. The encoder 1116 can provide feedback from the metering mechanism 1110 to the microprocessor 1102.

With reference to FIGS. 11 and 12, in some embodiments, the controller 1100 can include a control module. The control module can be coupled to the seed metering mechanism 1110 controlling the rate at which the seed mix is dispensed. In some embodiments, this can be the seed meter 1122. The control module can be configured to receive at least one feedback signal and/or an input signal. In some embodiments, the feedback signal and/or input signal can be a manual input signal, a sensor signal, and/or a GPS signal. The signal can come from a map source. The manual input signal can come from an electrical dial. The feedback signal and/or input signal can be an analog signal or a digital signal. The control module can be configured to convert analog signals to digital signals and convert digital signals to analog signals.

In other embodiments, the seed dispersion rate can be determined by various other means. For example, a linear actuator (not pictured) can be used to determine the rate at which seeds are dispensed/dispersed. The linear actuator can cause linear displacement of the metering mechanism 1110. Such a linear displacement can cause a change in a rate of seeds being dispensed from the seed meter 1122.

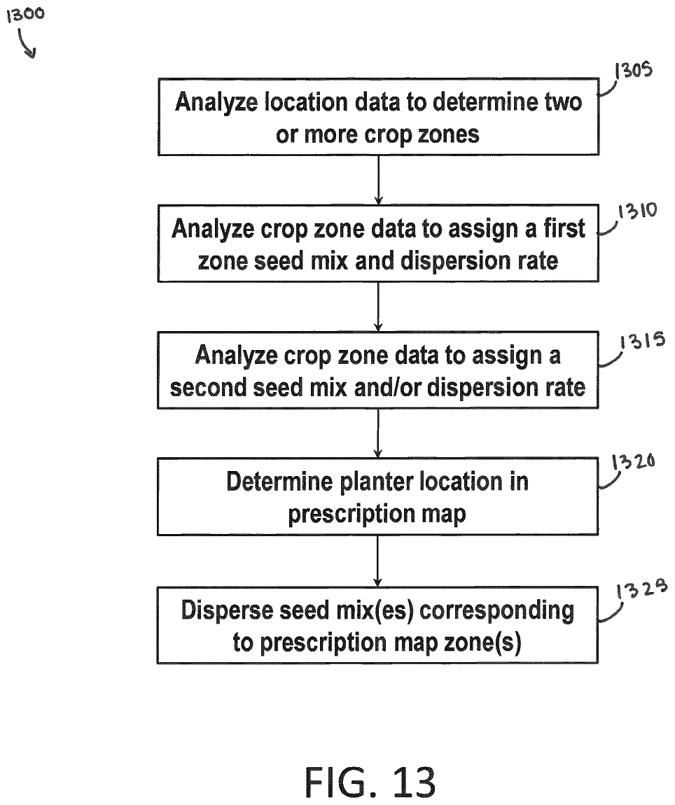

FIG. 13 shows a method of selecting and/or dispensing cover crops to be planted. The method can include analyzing location data to determine two or more crop zones (1305) within a crop area. The method can include analyzing crop zone data to assign a first zone seed mix and dispersion rate (1310). The method can include analyzing crop zone data to assign a second zone seed mix and/or dispersion rate (1315). The method can include determining the location of the planter in a prescription map (1320). The method can include dispersing seed mix(es) corresponding to prescription map zone(s) (1325). For example, the method may include dispersing an assigned seed mix and/or dispersion rate corresponding to the location of the planter in one zone of the prescription map zone(s). The analysis may be completed concurrent to operation of the planter. In other embodiments, the analysis can be completed prior to operation of the planter.

While the various systems described above are separate implementations, any of the individual components, mechanisms, or devices, and related features and functionality, within the various system embodiments described in detail above can be incorporated into any of the other system embodiments herein.

The term “about,” as used herein, refers to variation in the numerical quantity that can occur, for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The term “about” also encompasses these variations. The term “about” can include any variation of 5% or 10%, or any amount—including any integer—between 0% and 10%. Further, whether or not modified by the term “about,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

What is claimed is:

1. A precision planter for planting cover crops, the precision planter comprising:
(a) a frame configured to transport the precision planter through a crop area;
(b) at least one hopper coupled to the frame; and
(c) a seed dispersion system coupled to the frame, the seed dispersion system comprising:
(i) a first seed meter configured to selectively receive a first seed mix from the at least one hopper;
(ii) a funnel disposed below the first seed meter configured to receive the first seed mix from the at least one hopper;
(iii) a seed dispersion tube configured to receive the first seed mix;
(iv) a fan in fluidic communication with the seed dispersion tube, wherein the fan is configured to transport the first seed mix through the seed dispersion tube;
(v) a seed dispersion head in fluidic communication with the seed dispersion tube; and
(vi) a plurality of seed hoses in fluidic communication with the seed dispersion head, each of the plurality of seed hoses configured to deliver the first seed mix to the crop area, and
wherein the seed dispersion system is configured to implement a prescription map of the crop area comprising at least two cover crop zones, the at least two cover crop zones determined based on at least one of geographic data, topographic data, soil data, water retention data, and weather data to determine the first seed mix, the first seed mix corresponding to a first cover crop zone,
wherein the seed dispersion system is configured to disperse the first seed mix at a first seed dispersion rate in the first cover crop zone.

2. The precision planter of claim 1, wherein the seed dispersion system is configured to disperse the first seed mix at a second seed dispersion rate in a second cover crop zone, the second seed dispersion rate being different from the first seed dispersion rate.

3. The precision planter of claim 1, wherein the seed dispersion system is configured to disperse a second seed mix in a second cover crop zone, the second seed mix being different from the first seed mix.

4. The precision planter of claim 1, wherein the seed dispersion system is operable using a controller.

5. The precision planter of claim 1, wherein the geographic data comprises satellite data.

6. The precision planter of claim 1, wherein the at least one hopper comprises a plurality of hoppers, each hopper associated with a respective seed meter, each hopper being configured to dispense a respective seed mix, each respective seed mix comprising at least one type of seed or fertilizer, and wherein the seed dispersion system is configured to mix together the respective seed mixes.

7. The precision planter of claim 6, wherein the first seed mix comprises a single cover crop seed type.

8. The precision planter of claim 1, wherein the first seed mix comprises a fertilizer.

9. The precision planter of claim 1, wherein at least one cover crop zone comprises a fertilizer prescription zone.

10. A seed and/or fertilizer meter controller for a precision planter, comprising:
(a) a microprocessor;
(b) a seed metering adjuster configured to adjust a seed dispersion rate comprising a rate at which a seed is dispersed via a seed meter;
(c) an encoder configured to receive feedback and in communication with the microprocessor;
(d) a motor operably coupled to the seed metering adjuster; and
(e) a GPS receiver and antenna in communication with a secondary device and the microprocessor.

11. The controller of claim 10, wherein the seed metering adjuster comprises a linear actuator operably coupled to the motor.

12. The controller of claim 10, wherein the seed metering adjuster comprises a code generator and wherein the encoder is operably connected to the motor.

13. The controller of claim 12, wherein the seed metering adjuster comprises a linear actuator operably connected to the motor and encoder.

14. The controller of claim 10, further comprising a control module electronically coupled to the seed metering adjuster and the motor, wherein the control module is configured to control the seed metering adjuster.

15. The controller of claim 14, wherein the control module is configured to receive at least one of a feedback signal or an input signal to modify a seed mix being dispersed by the precision planter, wherein the seed mix comprises at least one seed type.

16. The controller of claim 15, wherein the feedback signal or control signal comprises at least one of a manual input signal, a sensor signal, and a GPS signal.

17. The controller of claim 16, wherein the feedback signal or control signal comprises an analog signal, and wherein the control module is configured to convert the analog signal to a digital signal.

18. The controller of claim 15, wherein the feedback signal or control signal comprises a digital signal, and wherein the control module is configured to convert the digital signal to an analog signal.

19. The controller of claim 12, wherein the code generator comprises a logic unit configured to generate a mixture of seed and/or the seed dispersion rate.

20. The controller of claim 10, wherein the motor comprises a stepper motor.

21. A seed mixing device, comprising at least one layer, the at least one layer comprising:
(a) a layer body comprising a first end and a second end opposite the first end; and
(b) at least one opening extending from the first end to the second end at at least one angle, and
wherein the at least one angle of the at least one opening is greater than an angle of repose of a seed to be disposed in a hopper.

22. The seed mixing device of claim 21, wherein each of the at least one layers is configured to be disposed above or below an adjacent layer, and
wherein each of the at least one angles of a layer comprises a different angle and/or orientation from the at least one angle of an adjacent layer.
